(19) United States
(12) Patent Application Publication
(10) Pub. No.: US 2026/0313359 A1
(43) Pub. Date: Oct. 8, 2026

(54) User Equipment Processing and Capabilities for Multiple Receive Chain Reception

(71) Applicant: Apple Inc., Cupertino, CA (US)

(72) Inventors: Manasa RAGHAVAN, Sunnyvale, CA (US); Andre JANSSEN, Meunchen (DE); Konstantinos SARRIGEORGIDIS, Los Gatos, CA (US); Xiang CHEN, Palo Alto, CA (US); Yang TANG, San Jose, CA (US)

(21) Appl. No.: 19/482,952

(22) PCT Filed: May 10, 2024
(86) PCT No.: PCT/US2024/028757

§ 371 Date: Nov. 10, 2025

Related U.S. Application Data
(60) Provisional application No. 63/501,200, filed on May 10, 2023.

(51) Int. Cl. H04W 8/22; H04B 7/06; H04B 17/309; H04B 17/318; H04W 24/10

(52) U.S. Cl. CPC H04W 8/22; H04B 7/0626; H04B 17/328; H04B 17/346; H04W 24/10

(57) ABSTRACT

An apparatus configured to generate, for transmission to a base station, an indication of a processing capability comprising a joint processing capability, a separate processing capability, or both the joint processing capability and the separate processing capability, process, based on signals received from the base station, configuration information identifying, based on the indication of the processing capability, a suitable multi-transmission and reception point (TRP) transmission scheme and which processing capability to use and use the identified processing capability and multi-TRP transmission scheme for multi-TRP reception with a first TRP and a second TRP.

### PRIORITY/INCORPORATION BY REFERENCE

This Application claims priority to U.S. Provisional Application Serial No. 63/501,200 entitled “User Equipment Processing And Capabilities For Multiple Receive Chain Reception,” filed on May 10, 2023, the entirety of which is incorporated herein by reference.

### BACKGROUND

A user equipment (UE) may connect to a network via a base station. The base station may control multiple transmission and reception points (TRPs). In some scenarios, the UE may operate in multi-TRP (mTRP) mode where the UE establishes and maintains a connection with multiple TRPs at the same time. It has been identified that there is a need to improve support for mTRP operation, in particular in situations with simultaneous multi-receive-chain (multi-RX chain) reception for multiple TRPs.

### SUMMARY

Some example embodiments are related to an apparatus having processing circuitry configured to generate, for transmission to a base station, an indication of a processing capability comprising a joint processing capability, a separate processing capability, or both the joint processing capability and the separate processing capability, process, based on signals received from the base station, configuration information identifying, based on the indication of the processing capability, a suitable multi-transmission and reception point (TRP) transmission scheme and which processing capability to use and use the identified processing capability and multi-TRP transmission scheme for multi-TRP reception with a first TRP and a second TRP.

Other example embodiments are related to an apparatus having processing circuitry configured to use a first one of one or more processing capabilities for multi-transmission and reception point (TRP) reception from a first TRP and a second TRP, wherein the one or more processing capabilities comprise joint processing, separate processing, or both joint and separate processing and switch from the first one of the one or more processing capabilities to a second one of the one or more processing capabilities.

Still further example embodiments are related to an apparatus having processing circuitry configured to process, based on signals received from a user equipment (UE), an indication indicating the UE is capable of joint processing, separate processing, or both joint and separate processing, and wherein the UE is configured to receive a first beam from a first transmission and reception point (TRP) and a second beam from a second TRP such that the UE is configured to receive multiple TRP-RX pairs from the first TRP and the second TRP and generate, for transmission to the UE, configuration information identifying, based on the indication of the processing capability, a suitable multi-TRP transmission scheme and which processing capability for the UE to use for multi-TRP reception with the first TRP and the second TRP.

Additional example embodiments are related to an apparatus having processing circuitry configured to process, based on signals received from a user equipment (UE) configured to receive a first beam from a first transmission and reception point (TRP) and a second beam from a second TRP such that the UE is configured to process multiple TRP-RX pairs from the first TRP and the second TRP, a message comprising an indication that the UE is capable of both joint processing and separate processing and that a first one of the joint processing and separate processing is currently being used and generate, for transmission to the UE, an instruction to the UE for the UE to switch from the first one of the joint processing and separate processing to a second one of the joint processing and separate processing.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example system diagram illustrative of a device simultaneously receiving beams from two different cells, according to various example embodiments.

FIG. 5 shows an example diagram illustrating two TRPs with corresponding SSBs, according to various example embodiments.

FIG. 6 shows an example diagram illustrating two TRPs and respective associated CSI-RS resources, according to various example embodiments.

FIG. 7 shows an example flow diagram illustrating a method for a UE to share its processing capabilities with the network such that the UE may use a suitable multi-TRP transmission scheme and the most efficient of its processing capabilities for multi-RX reception from multiple TRPs according to various example embodiments.

FIG. 8 shows an example flow diagram illustrating a method for a UE to share its processing capabilities with the network to enable dynamic switching of the UE's processing capabilities for multi-RX reception from multiple TRPs according to various example embodiments.

### DETAILED DESCRIPTION

### The Example Embodiments May Be Further Understood

with reference to the following description and the related appended drawings, wherein like elements are provided with the same reference numerals. The example embodiments relate to beam management and multi-transmission reception point (mTRP) operation, and in particular, determining whether simultaneous multi-RX reception is feasible.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a fifth generation (5G) New Radio (NR) network and a next generation node B (gNB). However, reference to a 5G NR network and a gNB is merely provided for illustrative purposes. The example embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

In addition, each gNB may support one or more cells. Throughout this description, the term “source cell” may refer to a cell operated by a source gNB. Similarly, the term “target cell” may refer to a cell operated by a target gNB. Since each gNB may support one or more cells, there may be a scenario in which multiple target cells are associated with the same target gNB. The UE may communicate with a cell over the air via a TRP. Due to the relationship between a TRP and a cell, the terms “TRP” and “cell” may be used interchangeably. For instance, in some examples, a “target cell” and a “target TRP” may be used interchangeably to generally refer to the same connection and/or node.

The UE may perform measurements on one or more neighbor cells using a specific downlink reference signal, e. g., a signal synchronization block (SSB) or a channel state information (CSI)-reference signal (RS). The measurements may be based on SSB, CSI-RS or any other appropriate downlink resource. The measurement metric may be L1-reference signal received power (RSRP), L1-signal interference-to-noise ratio (SINR), L1-reference signal received quality (RSRQ) or any other appropriate type of metric. However, any reference to a specific type of measurement, reference signal or metric is merely provided for illustrative purposes. The example embodiments may apply to any appropriate type of measurement, reference signal or metric.

The example embodiments describe operations for a user equipment (UE) to share its processing capabilities with the network such that the UE may use a suitable multi-TRP transmission scheme and the most efficient of its processing capabilities for multi-RX reception from multiple TRPs. In a multi-TRP scheme, a UE may be configured to receive a first beam from a first transmission and reception point (TRP) and a second beam from a second TRP such that the UE is configured to receive multiple TRP-RX pairs from the first TRP and the second TRP. The UE has one or more processing capabilities. Specifically, the UE may be capable of joint processing, separate processing, or both joint and separate processing, as described above. In joint processing, the UE is configured to consider all of the multiple TRP-RX pairs. In separate processing, the UE is configured to consider only one of the multiple TRP-RX pairs (usually the strongest TRP-RX pair) and will treat all other ones of the multiple TRP-RX pairs as interference.

As described herein, a UE may transmit an indication of a processing capability to a base station, where the indication indicates to the base station that the UE is capable of joint processing, separate processing, or both joint and separate processing. The UE receives configuration information from the base station, where the configuration information identifies, based on the indication of the processing capability, a suitable multi-TRP transmission scheme and which processing capability for the UE to use. The UE then may use the identified processing capability and multi-TRP transmission scheme for multi-TRP reception with the first TRP and the second TRP.

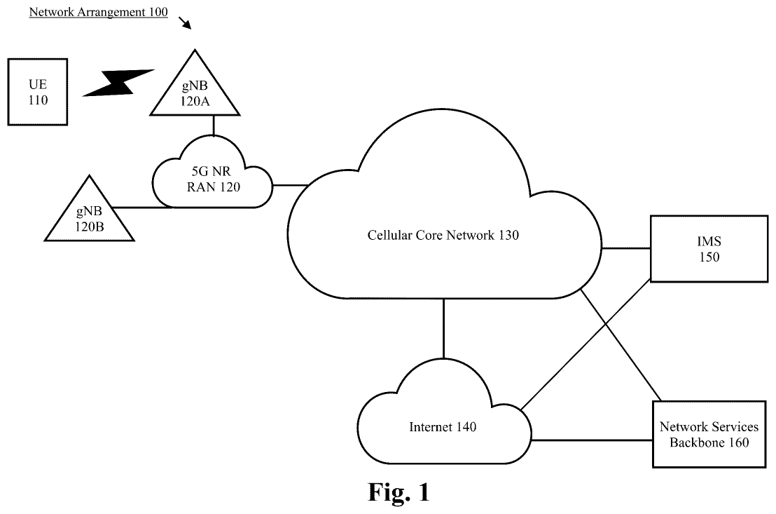

FIG. 1 shows an example network arrangement 100 according to various example embodiments. The example network arrangement 100 includes a UE 110. The UE 110 may be any type of electronic component that is configured to communicate via a network, e. g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

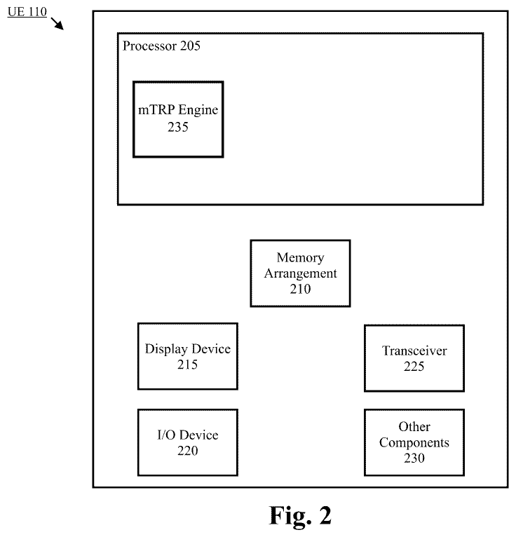

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP engine 235. The mTRP engine 235 may perform various operations related to mTRP operation. To provide some general examples, the mTRP engine 235 may perform operations such as, but not limited to, dynamically switching between mTRP mode and sTRP mode, updating a CC-group for mTRP operation and determining a default downlink beam/TCI-state for mTRP PDSCH reception.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

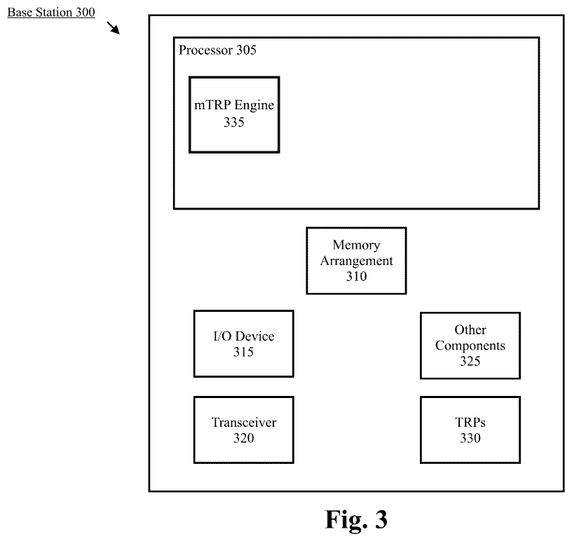

FIG. 3 shows an example base station 300 according to various example embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 330 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 330 may be deployed locally at the base station 300. In other scenarios, one or more of the multiple TRPs 330 may be deployed at physical locations remote from the base station 300 and connected to the base station via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a mTRP engine 335. The mTRP engine 335 may perform various operations related to mTRP operation. To provide some general examples, the mTRP engine 335 may perform operations such as, but not limited to, transmitting a signal to trigger the UE 110 to dynamically switch between mTRP mode and sTRP mode, transmitting information to update a CC-group for mTRP operation and indicating a default downlink beam/TCI-state for mTRP PDSCH reception.

The above noted engine 335 being an application (e.g., a program) executed by the processor 305 is only an example. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e. g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As previously mentioned, wireless communications, such as NR cellular wireless communications, involve measurement and reporting of various channel and communication metrics. The evolution of 5G New Radio (NR) requires support for UE processing and capabilities for multi-RX reception (such as on the downlink).

In Release 18 (R18) of the 3GPP standard, a requirement for multi-RX chain downlink (DL) reception was formulated with certain objectives for UE demodulation. These objectives include specifying performance requirements for enhanced NR frequency range 2 (FR2-1) UEs supporting up to four downlink (DL) multiple-input, multiple-output (MIMO) layers with dual transmission configuration indication (TCI) with different quasi-co-located (QCL) typeD signals on a single component carrier. These performance requirements include demodulation requirements on up to four DL MIMO layers and CSI requirements to support up to 4-layer with two TCIs and Rel-17 mTRP Type I codebook.

There are several possible multi-TRP schemes for multi-RX reception. These include a Multi-DCI (multiple Downlink Control Information) transmission scheme, which may be non-overlapping (at least in frequency, though might be same time), fully-overlapping (in both time and frequency), and partially overlapping. Another possible scheme is a single DCI transmission scheme, which might be a spatial domain multiplexing (SDM transmission scheme) or a frequency domain multiplexing (FDM) A/B transmission scheme.

A UE may be able to process reception from different RX chains in different ways. For example, a UE may use joint processing of TRP-RX pairs (links) in a 4×4 MIMO scheme. In the alternative, the UE may use separate processing of two TRP-RX pairs, such as in a two times 2×2 processing scheme. In separate processing, the UE processes only a single TRP-RX pair (link). There may be advantages and disadvantages of both joint processing and single processing. The current disclosure describes ways to take advantage of the benefits of each while minimizing the disadvantages of each.

Depending on the particular arrangement, a UE might have either one of the joint processing or separate processing capabilities. In another example, the UE may have both joint and separate processing capabilities, and the UE might have the further capability of switching between the two processing capabilities depending on conditions. However, the network may not be aware of the UE's processing capabilities. If the network were able to get information about the UE's processing capabilities, the network may use such information to improve scheduling of resources.

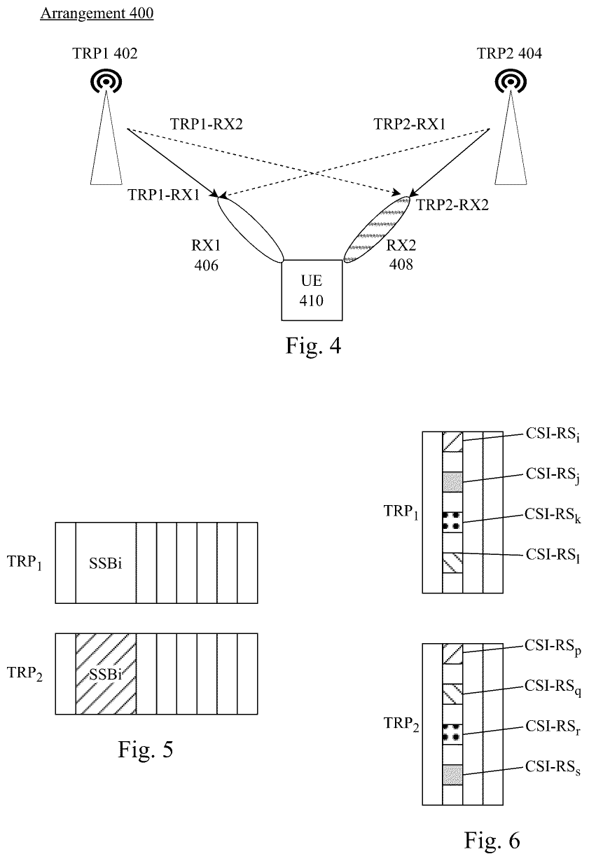

As disclosed herein, for multi-RX support, a UE may support measurement and reporting functionalities (such as group-based beam reporting) to measure and report on multiple received beams, for example on a pair of beams received simultaneously. FIG. 4 shows an example system diagram illustrative of a device 410 simultaneously receiving a beam 406 (RX1) from a first cell 402 (TRP1-RX1) and a beam 408 (RX2) from a second cell 404 (TRP2-RX2). As shown in FIG. 4, the respective angle of arrival (AoA) for each beam may be different at UE 410. Depending on the arrangement of the two cells (TRP 402 and 404), there may be undesirable crosstalk between the two TRPs, as indicated by the dotted lines TRP1-RX2 and TRP2-RX1). Although two TRPS are shown in FIG. 4 for convenience, there may be more than two TRPs and accordingly, more than two TRP-RX pairs.

As mentioned above, the UE, such as UE 110 or 410 disclosed herein, may be capable of both joint processing and separate processing. In joint processing, the UE 110 may consider all available TRP-RX pairs. Joint processing may be favorable when transmission from the two TRPs are overlapped in time and frequency. Joint processing may also be favorable when the “cross-talk” between the two TRPs is strong, or when there is only a small separation between TRPs, or when there is a high correlation in received signals from TRPs at each Rx due to the UE panel placement.

Separate processing is processing each TRP-Rx link separately. In separate processing, only the strongest TRP-RX link is considered (e.g., TRP1-RX1 and TRP2-RX2). The other TRP-RX (e.g., TRP1-RX2 and TRP2-RX1) is treated as interference. Separate processing may be favorable when there is good separation and/or isolation between the links. Separate processing may also be favorable in schemes with non-overlapped frequency resources, such as single DCI FDM or non-overlapped multi-DCI.

As mentioned above, the UE 110 may have both joint and separate processing capabilities, and the UE 110 might have the further capability of switching between the two processing capabilities depending on conditions. However, the network may not be aware of the UE's processing capabilities. If the network were able to get information about the UE's processing capabilities, the network may use such information to improve scheduling of resources.

One way to take advantage of the UE 110 having both joint and separate processing capabilities is for the UE 110 to indicate its processing capabilities to the network, such as to a gNB or other base station. The UE 110 may indicate to the network that the UE 110 supports single TRP-RX processing (separate processing) only, that the UE 110 supports joint TRP-RX processing only, or that the UE 110 supports both single and joint TRP-RX processing. In some embodiments, the capability signaling can be indicated to the network via radio resource control (RRC) signaling. In this manner, once a FR2 network is aware of the UE's capability, the network can use multi-TRP capability along with multi-RX processing capability to configure the UE 110 with suitable multi-TRP transmission schemes. In particular, with joint processing capability and the appropriate transmission scheme, the UE 110 would be able to achieve higher capacity and/or throughput in conditions with less isolation between TRPs and/or a high correlation in received signals from two or more TRPs than with separate processing.

In another embodiment, if the UE 110 has both joint processing and separate processing capabilities, the UE 110 may have the capability for dynamic signaling, where the UE 110 is capable of both processing schemes may switch from single link (separate) processing to joint processing, or vice versa. In one example, the UE 110 may switch from joint processing to separate processing based on measurements performed at the UE 110. These measurements may include any suitable measurements, including SINR, RSRP, and/or cross link measurements. In the case of similar RSRP and/or SINR measurements, the UE 110 may use joint processing. If the measurements indicate strong TRP-RX links and weak cross link measurements (which may indicate that there is good isolation between the TRPs), the UE 110 may use single link processing. The UE 110 may indicate to the network (such as to gNB 120A) which type of processing is used. The network (e.g., base station 120A) may utilize the indication of which type of processing the UE 110 is using to schedule resources accordingly. Further, the network may use the indication of the UE 110′s processing capability in conjunction with other feedback from the UE 110, such as CSI feedback, to schedule resources in an improved and more efficient manner. The dynamic signaling of the UE 110′s processing capabilities may be done via medium access control (MAC) control element (CE) commands and/or through radio resource control (RRC) signaling.

The measurements used decide whether to switch between types of processing for the UE may be any type of measurements. In one embodiment, the measurements may be sent from the UE 110 to the gNB via a measurement report. The measurement report may include group-based beam reporting in some embodiments. The following functionality (e.g., by way of communication parameters) may thereby be implemented:
groupBeamReporting to report L1-RSRP on one (1) pair of received beams;
groupSINR-reporting-r16 to report L1-SINR on one (1) pair of received beams; and
mTRP-GroupBasedL1-RSRP-r17 to report L1-RSRP on up to four (4) pairs of received beams.

In addition, L1 measurements may be enhanced to support group-based reporting for at least the following:
SSB based (simultaneous) L1-RSRP measurements,
CSI-RS based (simultaneous) L1-RSRP measurements, and
CSI-RS based (simultaneous) L1-SINR measurements.

### SSB Based Measurement-L1-RSRP

SSB Based L1-RSRP measurement(s) for single RX are currently defined for a serving cell, and for a cell with a different PCI than the serving cell (for inter-cell beam management). For multi-RX reception, for example with simultaneous beam reception, requirements may be defined for:
1. simultaneous reception from a serving cell and a cell with a different PCI (than the serving cell) ; and
2. simultaneous reception and L1-RSRP of two (2) SSBs from a serving cell and a cell with different PCI (than the serving cell).

Regarding (1) above, SSBs from the same cell with the same index may not be transmitted from different transmission and reception points (TRPs), and each SSB index may be associated with a TX beam. Regarding (2) above, there are currently sharing factors/resource sharing between the serving cell and a cell with a different PCI (than the serving cell), for overlapping SSBs. With simultaneous reception, the UE may measure both simultaneously, with no sharing factor or resource sharing required. FIG. 5 shows an example diagram illustrating two TRPs with corresponding SSBs. The UE may simultaneously receive the respective SSBs from TRP1 and TRP2 and measure both simultaneously to obtain the L1-RSRP measurements.

### CSI-RS Based Measurement-L1 RSRP

Support may also be provided for CSI-RS based measurements with multi-RX chains. In some embodiments, two sets of resources may be configured for each TRP/AoA (Angle of Arrival). For example, a number (N) of resources may be defined per set, and/or the UE may take measurements for a pair of resources simultaneously. As an example, for the measurement of one resource (single TRP), the UE may acquire 8*T_{CSI-RS} samples for beam refinement. Accordingly, for measurement on one pair of non-overlapping resources, with simultaneous measurement, the UE may acquire 8* T_{CSI-RS} samples for beam refinement.

FIG. 6 shows an example diagram illustrating two TRPs, TRP1 and TRP2, and respective associated four pairs of overlapping CSI-RS resources (CSI-RSᵢ to CSI-RSⱼ and CSI-RSₚ to CSI-RSₛ, respectively). For two overlapping resources per set, the UE may measure on four pairs of resources, and if all resources are overlapping, the UE may acquire 4*8*T_{CSI-RS} samples for beam refinement/measurement. In general, for N overlapping resources on two sets, the UE may measure N² pairs of resources, acquiring N*N*8*T_{CSI-RS} samples for beam refinement/measurement.

### CSI-RS Based Measurement—L1 SINR

CSI-RS based L1-SINR measurements may be defined for at least two configurations, (1) CSI-RS based channel measurement resource (CMR) with no dedicated interference measurement resource (IMR) and (2) CSI-RS based CMR with dedicated IMR. For (1), both signal and interference may be measured on the same resource. For (2), the signal and interference may be measured on different resources.

In some embodiments, group-based L1-SINR reporting may be supported for one pair of resources. The current requirements may be applicable, with the UE supporting multi-RX chain measurements on a pair of resources, for example supporting simultaneous measurements over multi-RX chains. Accordingly, the UE may acquire 8*T_{CSI-RS} samples for beam refinement for measurement on one pair of resources.

Group-based beam reporting may be extended to up to ‘N’ resources for multi-RX chain/multi-TRP measurements. For measurements on one pair of non-overlapping resources, e.g., when simulations measurements are performed, the UE may acquire 8*T_{CSI-RS} samples for beam refinement. For two overlapping resources per set, the UE may measure on four pairs of resources. If all resources are overlapping, 4*8*T_{CSI-RS} samples may be acquired for beam refinement/measurement. For N overlapping resources on two sets, the UE may measure N² pairs of resources, acquiring N*N*8*T_{CSI-RS} samples for beam refinement/measurement.

### Example Methods

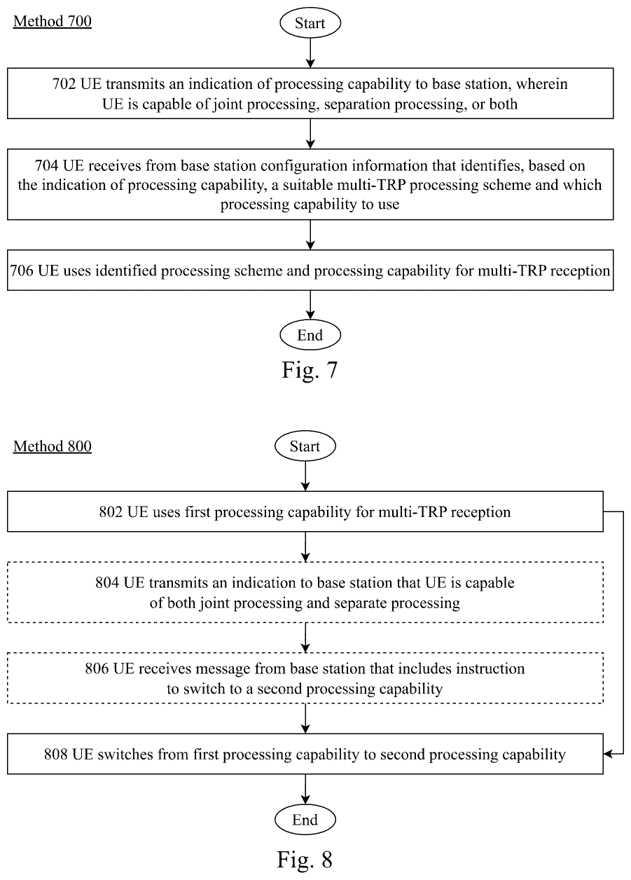

FIG. 7 shows an example flow diagram illustrating a method (700) for a user equipment (UE) to share its processing capabilities with the network such that the UE may use a suitable multi-TRP transmission scheme and the most efficient of its processing capabilities for multi-RX reception from multiple TRPs. In a multi-TRP scheme, a UE, such as UE 110 or 410 described herein, may be configured to receive a first beam from a first transmission and reception point (TRP) and a second beam from a second TRP such that the UE is configured to receive multiple TRP-RX pairs from the first TRP and the second TRP, and wherein the UE has one or more processing capabilities. Specifically, the UE may be capable of joint processing, separate processing, or both joint and separate processing, as described above. In joint processing, the UE is configured to consider all of the multiple TRP-RX pairs. In separate processing, the UE is configured to consider only one of the multiple TRP-RX pairs (usually the strongest TRP-RX pair) and will treat all other ones of the multiple TRP-RX pairs as interference.

In one embodiment, as seen in FIG. 7, the UE 110 may transmit an indication of a processing capability to a base station, such as gNB 120A (702). The indication indicates to the base station 120A that the UE 110 is capable of joint processing, separate processing, or both joint and separate processing. The transmitting of the indication may be done using medium access control (MAC) control element (CE) commands and/or through radio resource control (RRC) signaling in one embodiment. In response to this indication sent by the UE 110, the base station 120A may send configuration information to be received by the UE 110, wherein the configuration information identifies, based on the indication of the processing capability, a suitable multi-TRP transmission scheme and which processing capability for the UE 110 to use (704). The configuration information received by the UE 110 may also include indicating beam resources for multiple TRPs. In 706, the UE 110 may then use the identified processing capability and multi-TRP transmission scheme for multi-TRP reception with the first TRP and the second TRP.

In one embodiment, not shown in FIG. 7, the UE 110 may optionally perform measurements on both the first beam and the second beam. In some examples, the measurements may include physical layer (L1) measurements including one or more of: (a) L1 reference signal received power (L1-RSRP) measurements based on respective synchronization signal blocks (SSBs) associated with the first beam and the second beam; (b) L1-RSRP measurements based on respective channel state information reference signals (CSI-RSs) associated with the first beam and the second beam; and/or (c) L1 signal-to-interference-plus-noise ratio (L1-SINR) measurements based on respective channel state information reference signals (CSI-RSs) associated with the first beam and the second beam. The UE 110 may transmit a measurement report to the base station, the measurement report including the measurements performed on the first beam and the second beam performed at the UE.

In one example, measurement information be used to schedule an appropriate transmission scheme and for the UE 110 to use the most appropriate processing capability. For example, the measurements may be used by the base station 120A in one example to determine the configuration information to be sent to the UE 110. For example, the configuration information received by the UE 110 will configure the UE 110 to use joint processing when the measurements performed at the UE 110 indicate that the first beam from the first TRP and the second beam from the second TRP are transmitted such that the first beam and the second beam overlap in time and frequency. In another example, the configuration information will configure the UE 110 to use joint processing when the measurements performed at the UE indicate that an unacceptable amount of cross talk exists between the multiple TRP-RX pairs and/or the measurements performed at the UE indicate a high correlation in received signals from the first TRP and the second TRP.

In another example embodiment, the configuration information will configure the UE 110 to use separate processing when the measurements performed at the UE 110 indicate that a good separation or isolation between the multiple TRP-RX pairs exists. In another example, the configuration information will configure the UE 110 to use separate processing when the identified multi-TRP transmission scheme is one with non-overlapped frequency resources. In this example, the identified multi-TRP transmission scheme may be a single Downlink Control Information (DCI) Frequency Domain Multiplexing (FDM) scheme or a non-overlapped multi-DCI scheme.

In another example embodiment, not shown in FIG. 7, the UE 110 may receive a message from the base station that includes an instruction for the UE to switch which type of processing to use. This instruction may be based on the measurements performed at the UE.

FIG. 8 shows an example flow diagram illustrating a method (800) for a user equipment (UE) to share its processing capabilities with the network to enable dynamic switching of the UE's processing capabilities for multi-RX reception from multiple TRPs. In a multi-TRP scheme, a UE, such as UE 110 or 410 described herein, may be configured to receive a first beam from a first transmission and reception point (TRP) and a second beam from a second TRP such that the UE is configured to receive multiple TRP-RX pairs from the first TRP and the second TRP, and wherein the UE has one or more processing capabilities. Specifically, as described above, the UE may be capable of joint processing, separate processing, or both joint and separate processing, as described above.

In one example embodiment, as seen in FIG. 8, a UE, such as UE 110 or 410 described herein, may be capable of both joint processing and separate processing. In 802, the UE 110 uses a first one of the one or more processing capabilities for multi-TRP reception from the first TRP and the second TRP. In 808, the UE 110 switches from the first one of the one or more processing capabilities to the second one of the one or more processing capabilities. That is, if the UE 110 was originally using joint processing, it may switch to separate processing. If the situation where the UE 110 was originally using separate joint processing, the UE 110 may switch to joint processing. In one example, though not required, the switch may occur after the UE 110 transmits an indication to a base station, such as gNB 120A, that the UE is capable of both joint processing and separate processing and that the first one of the one or more processing capabilities is currently being used (804) and the UE 110 receives a message from the base station, such as gNB 120A, the message comprising an instruction for the UE to switch from the first one of the one or more processing capabilities to a second one of the one or more processing capabilities (806).

In one example, not shown in FIG. 8, the UE 110 may also receive configuration information from the base station, where the configuration information identifies, based on the indication of the processing capability, a suitable multi-TRP transmission scheme and processing capability for the UE to use.

In another example embodiment, the UE 110 may perform measurements on both the first beam and the second beam to obtain measurement information that may be used in deciding whether to switch between processing schemes. For example, the UE 110 may perform physical layer (L1) measurements including one or more of: (a) L1 reference signal received power (L1-RSRP) measurements based on respective synchronization signal blocks (SSBs) associated with the first beam and the second beam; b) L1-RSRP measurements based on respective channel state information reference signals (CSI-RSs) associated with the first beam and the second beam; and/or (c) L1 signal-to-interference-plus-noise ratio (L1-SINR) measurements based on respective channel state information reference signals (CSI-RSs) associated with the first beam and the second beam. Based on these measurements, the UE 110 may switch from the first one of the one or more processing capabilities to the second one of the one or more processing capabilities.

In another example embodiment, it is the base station 120A that determines whether to switch processing schemes. The UE 110 may transmit measurement information to the base station. The base station 120A can then determine, based on the measurement information, that a switch is desirable. The base station 120A can then transmit an instruction for the UE to switch from the first one of the one or more processing capabilities to the second one of the one or more processing capabilities is received from the base station based on the measurement information.

For example, if the measurements for the first beam and the second beam are similar, and the first one of the processing capabilities is separate processing, the switching is from separate processing to joint processing. Alternatively, if the measurements for the first beam and the second beam indicate a strong separate TRP-RX pair and/or weak cross link between the multiple TEP-RX pairs, and the first one of the processing capabilities is joint processing, the instruction received at the UE may be to switch from joint processing to separate processing. In one embedment, the messaging between the UE 110 and the base station 120A may be via medium access control (MAC) control element (CE) commands.

### EXAMPLES

In a first example, a method for wireless communications comprising at a user equipment configured to receive a first beam from a first transmission and reception point (TRP) and a second beam from a second TRP such that the UE is configured to receive multiple TRP-RX pairs from the first TRP and the second TRP, and wherein the UE has one or more processing capabilities, transmitting an indication of a processing capability to a base station, where the indication indicates to the base station that the UE is capable of joint processing, separate processing, or both joint and separate processing, receiving configuration information from the base station, where the configuration information identifies, based on the indication of the processing capability, a suitable multi-TRP transmission scheme and which processing capability for the UE to use and using the identified processing capability and multi-TRP transmission scheme for multi-TRP reception with the first TRP and the second TRP.

In a second example, the method of the first example, further comprising performing, at the UE, measurements on both the first beam and the second beam.

In a third example, the method of the second example, wherein the measurements comprise physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a fourth example, the method of the first example, wherein for joint processing, the UE is configured to consider all of the multiple TRP-RX pairs.

In a fifth example, the method of the first example, wherein for separate processing, the UE is configured to consider only one of the multiple TRP-RX pairs and will treat all other ones of the multiple TRP-RX pairs as interference.

In a sixth example, the method of the second example, further comprising using joint processing when the measurements performed at the UE indicate that the first beam from the first TRP and the second beam from the second TRP are transmitted such that the first beam and the second beam overlap in time and frequency.

In a seventh example, the method of the second example, further comprising using joint processing when the measurements performed at the UE indicate that an unacceptable amount of cross talk exists between the multiple TRP-RX pairs and/or the measurements performed at the UE indicate a high correlation in received signals from the first TRP and the second TRP.

In an eighth example, the method of the second example, further comprising using separate processing when the measurements performed at the UE indicate that a good separation or isolation between the multiple TRP-RX pairs exists.

In a ninth example, the method of the second example, further comprising using separate processing when the identified multi-TRP transmission scheme is one with non-overlapped frequency resources.

In a tenth example, the method of the ninth example, wherein the identified multi-TRP transmission scheme is a single Downlink Control Information (DCI) Frequency Domain Multiplexing (FDM) scheme or a non-overlapped multi-DCI scheme.

In an eleventh example, the method of the first example, wherein the transmitting of the indication is via medium access control (MAC) control element (CE) commands and/or through radio resource control (RRC) signaling.

In a twelfth example, the method of the first example, wherein the configuration information transmitted from the base station further comprises information indicating beam resources for multiple TRPs.

In a thirteenth example, the method of the second example, further comprising transmitting a measurement report to the base station, the measurement report including the measurements performed on the first beam and the second beam performed at the UE.

In a fourteenth example, the method of the thirteenth example, further comprising receiving a message from the base station, the message comprising an instruction for the UE to switch which type of processing to use.

In a fifteenth example, the method of the fourteenth example, wherein the instruction to switch is based on the measurements performed at the UE.

In a sixteenth example, a processor configured to perform any of the methods of the first through fifteenth examples.

In a seventeenth example, a user equipment (UE) comprising a transceiver configured to communicate with a network and a processor communicatively coupled to the transceiver and configured to perform any of the methods of the first through fifteenth examples.

In an eighteenth example, a method for wireless communications comprising, at a user equipment (UE) configured to receive a first beam from a first transmission and reception point (TRP) and a second beam from a second TRP such that the UE is configured to process multiple TRP-RX pairs from the first TRP and the second TRP, and wherein the UE has one or more processing capabilities, the one or more processing capabilities comprising joint processing, separate processing, or both joint and separate processing, using a first one of the one or more processing capabilities for multi-TRP reception from the first TRP and the second TRP, switching from the first one of the one or more processing capabilities to the second one of the one or more processing capabilities.

In a nineteenth example, the method of the eighteenth example, further comprising transmitting an indication to a base station that the UE is capable of both joint processing and separate processing and that the first one of the one or more processing capabilities is currently being used, receiving a message from the base station, the message comprising an instruction for the UE to switch from the first one of the one or more processing capabilities to a second one of the one or more processing capabilities.

In a twentieth example, the method of the eighteenth example, further receiving configuration information from the base station, where the configuration information identifies, based on the indication of the processing capability, a suitable multi-TRP transmission scheme and processing capability for the UE to use.

In a twenty first example, the method of the eighteenth example, further comprising performing, at the UE, measurements on both the first beam and the second beam to obtain measurement information.

In a twenty second example, the method of the twentieth example, wherein the measurements performed by the UE comprise physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a twenty third example, the method of the twenty first example, where the switching from the first one of the one or more processing capabilities to the second one of the one or more processing capabilities is based on the measurement information.

In a twenty fourth example, the method of the twenty first example, further comprising transmitting the measurement information to the base station, and receiving a message from the base station comprising an instruction for the UE to switch from the first one of the one or more processing capabilities to the second one of the one or more processing capabilities, wherein the message is received from the base station in response to the measurement information.

In a twenty fifth example, the method of the twenty fourth example, wherein if the measurements for the first beam and the second beam are similar, and the first one of the processing capabilities is separate processing, the switching is from separate processing to joint processing.

In a twenty sixth example, the method of the twenty fourth example, wherein if the measurements for the first beam and the second beam indicate a strong separate TRP-RX pair and/or weak cross link between the multiple TRP-RX pairs, and the first one of the processing capabilities is joint processing, the instruction received at the UE is to switch from joint processing to separate processing.

In a twenty seventh example, the method of the nineteenth example, wherein the transmitting of the indication is via medium access control (MAC) control element (CE) commands.

In a twenty eighth example, a processor configured to perform any of the methods of the eighteenth through twenty seventh examples.

In a twenty ninth example, a user equipment (UE) comprising a transceiver configured to communicate with a network and a processor communicatively coupled to the transceiver and configured to perform any of the methods of the eighteenth through twenty seventh examples.

In a thirtieth example, a method for wireless communications, comprising, at a base station, receiving an indication of a processing capability from a user equipment (UE), where the indication indicates to the base station that the UE is capable of joint processing, separate processing, or both joint and separate processing, and wherein the UE is configured to receive a first beam from a first transmission and reception point (TRP) and a second beam from a second TRP such that the UE is configured to receive multiple TRP-RX pairs from the first TRP and the second TRP and transmitting configuration information to the UE, where the configuration information identifies, based on the indication of the processing capability, a suitable multi-TRP transmission scheme and which processing capability for the UE to use for multi-TRP reception with the first TRP and the second TRP.

In a thirty first example, the method of the thirtieth example, further comprising receiving measurement information from the UE, wherein the measurement information comprises measurements performed by the UE on both the first beam and the second beam.

In a thirty second example, the method of the thirty first example, wherein the measurements comprise physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a thirty third example, the method of the thirty first example, wherein the configuration information transmitted to the UE includes an instruction to use joint processing when the measurements performed at the UE indicate that the first beam from the first TRP and the second beam from the second TRP are transmitted such that the first beam and the second beam overlap in time and frequency.

In a thirty fourth example, the method of the thirty first example, wherein the configuration information transmitted to the UE includes an instruction to use joint processing when the measurements performed at the UE indicate that an unacceptable amount of cross talk exists between the multiple TRP-RX pairs and/or the measurements performed at the UE indicate a high correlation in received signals from the first TRP and the second TRP.

In a thirty fifth example, the method of the thirty first example, wherein the configuration information transmitted to the UE includes an instruction to use separate processing when the measurements performed at the UE indicate that a good separation or isolation between the multiple TRP-RX pairs exists.

In a thirty sixth example, the method of the thirty first example, wherein the configuration information transmitted to the UE includes an instruction to use separate processing when the identified multi-TRP transmission scheme is one with non-overlapped frequency resources.

In a thirty seventh example, the method of the thirty sixth example, wherein the identified multi-TRP transmission scheme is a single Downlink Control Information (DCI) Frequency Domain Multiplexing (FDM) scheme or a non-overlapped multi-DCI scheme.

In a thirty eighth example, the method of the thirtieth example, wherein the configuration information transmitted to the UE further comprises information indicating beam resources for multiple TRPs.

In a thirty ninth example, the method of the thirtieth example, further comprising transmitting a message to the UE, the message comprising an instruction for the UE to switch which type of processing to use.

In a fortieth example, the method of the thirty ninth example, wherein the instruction to switch is transmitted in response to, and is based on, the measurements performed at the UE.

In a forty first example, a processor configured to perform any of the methods of the thirtieth through fortieth examples.

In a forty second example, a base station comprising a transceiver configured to communicate with a user equipment (UE) and a processor communicatively coupled to the transceiver and configured to perform any of the methods of the thirtieth through fortieth examples.

In a forty third example, a method comprising, at a base station, receiving a message from a user equipment (UE), wherein the UE is configured to receive a first beam from a first transmission and reception point (TRP) and a second beam from a second TRP such that the UE is configured to process multiple TRP-RX pairs from the first TRP and the second TRP, and wherein the message comprises an indication that the UE is capable of both joint processing and separate processing and that a first one of the joint processing and separate processing is currently being used, transmitting an instruction to the UE for the UE to switch from the first one of the joint processing and separate processing to a second one of the joint processing and separate processing.

In a forty fourth example, the method of the forty third example, further comprising transmitting configuration information to the UE, where the configuration information identifies, based on the indication of the processing capability, a suitable multi-TRP transmission scheme and processing capability for the UE to use.

In a forty fifth example, the method of the forty third example, further comprising receiving, from the UE, a measurement report comprising measurements performed on both the first beam and the second beam at the UE.

In a forty sixth example, the method of the forty fifth example, wherein the measurements performed by the UE and included in the measurement report comprise physical layer (L1) measurements including one or more of (a) L1 reference signal received power (L1-RSRP) measurements based on respective synchronization signal blocks (SSBs) associated with the first beam and the second beam, (b) L1-RSRP measurements based on respective channel state information reference signals (CSI-RSs) associated with the first beam and the second beam or (c) L1 signal-to-interference-plus-noise ratio (L1-SINR) measurements based on respective channel state information reference signals (CSI-RSs) associated with the first beam and the second beam.

In a forty seventh example, the method of the forty fifth example, wherein the instruction for the UE to switch from the first one of the of the joint processing and separate processing to the second one of the of the joint processing and separate processing is based on the measurement information.

In a forty eighth example, the method of the forty seventh example, wherein if the measurements for the first beam and the second beam are similar, and the first one of the processing capabilities is separate processing, the instruction to switch is to switch from separate processing to joint processing.

In a forty ninth example, the method of the forty seventh example, wherein if the measurements for the first beam and the second beam indicate a strong separate TRP-RX pair and/or weak cross link between the multiple TEP-RX pairs, and the first one of the processing capabilities is joint processing, the instruction to switch is an instruction to switch from joint processing to separate processing.

In a fiftieth example, a processor configured to perform any of the methods of the forty third through forty ninth examples.

In a fifty first example, a base station comprising a transceiver configured to communicate with a user equipment (UE) and a processor communicatively coupled to the transceiver and configured to perform any of the methods of the forty third through forty ninth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICS. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
generate, for transmission to a base station, an indication of a processing capability comprising a joint processing capability, a separate processing capability, or both the joint processing capability and the separate processing capability;
process, based on signals received from the base station, configuration information identifying, based on the indication of the processing capability, a suitable multi-transmission and reception point (TRP) transmission scheme and which processing capability to use; and
use the identified processing capability and multi-TRP transmission scheme for multi-TRP reception with a first TRP and a second TRP.

2. The apparatus of claim 1, wherein the processing circuitry is further configured to:
process measurements on a first beam transmitted by the first TRP and a second beam transmitted by the second TRP.

3. The method of claim 2, wherein the measurements comprise physical layer (L1) measurements including one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam; or
(c) L1 signal-to-interference-plus-noise ratio (L1-SINR) measurements based on respective channel state information reference signals (CSI-RSs) associated with the first beam and the second beam.

4. The apparatus of claim 2, wherein the processing circuitry is further configured to:
use joint processing when the measurements performed at the UE indicate that the first beam from the first TRP and the second beam from the second TRP are transmitted such that the first beam and the second beam overlap in time and frequency.

5. The apparatus of claim 2, wherein the processing circuitry is further configured to:
use joint processing when the measurements performed at the UE indicate that an unacceptable amount of cross talk exists between multiple TRP-reception (RX) pairs or the measurements performed at the UE indicate a high correlation in received signals from the first TRP and the second TRP.

6. The apparatus of claim 2, wherein the processing circuitry is further configured to:
use separate processing when the measurements performed at the UE indicate that a good separation or isolation between multiple TRP-reception (RX) pairs exists.

7. The apparatus of claim 2, wherein the processing circuitry is further configured to:
use separate processing when the identified multi-TRP transmission scheme is one with non-overlapped frequency resources.

8. The apparatus of claim 2, wherein the processing circuitry is further configured to:
generate, for transmission to the base station, a measurement report including the measurements performed on the first beam and the second beam.

9. The apparatus of claim 8, wherein the processing circuitry is further configured to:
process, based on signals received from the base station, a message comprising an instruction UE to switch which type of processing to use.

10. The apparatus of claim 1, wherein the configuration information received from the base station further comprises information indicating beam resources for multiple TRPs.

11. An apparatus comprising processing circuitry configured to:
use a first one of one or more processing capabilities for multi-transmission and reception point (TRP) reception from a first TRP and a second TRP, wherein the one or more processing capabilities comprise joint processing, separate processing, or both joint and separate processing; and
switch from the first one of the one or more processing capabilities to a second one of the one or more processing capabilities.

12. The apparatus of claim 11, wherein the processing circuitry is further configured to:
generate, for transmission to a base station, an indication of a joint processing capability and a separate processing capability and that the first one of the one or more processing capabilities is currently being used; and
process, based on signals received from the base station, a message comprising an instruction to switch from the first one of the one or more processing capabilities to the second one of the one or more processing capabilities.

13. The apparatus of claim 12, wherein the processing circuitry is further configured to:
process, based on signals received from the base station, configuration information identifying, based on the indication of the processing capability, a suitable multi-TRP transmission scheme and processing capability to use.

14. The apparatus of claim 12, wherein the transmitting of the indication is via medium access control (MAC) control element (CE) commands.

15. The apparatus of claim 11, wherein the processing circuitry is further configured to:
process measurements on a first beam transmitted by the first TRP and a second beam transmitted by the second TRP to obtain measurement information.

16. The apparatus of claim 15, wherein the measurements comprise physical layer (L1) measurements including one or more of:
(a) L1 reference signal received power (L1-RSRP) measurements based on respective synchronization signal blocks (SSBs) associated with the first beam and the second beam;
(b) L1-RSRP measurements based on respective channel state information reference signals (CSI-RSs) associated with the first beam and the second beam; or
(c) L1 signal-to-interference-plus-noise ratio (L1-SINR) measurements based on respective channel state information reference signals (CSI-RSs) associated with the first beam and the second beam.

17. The apparatus of claim 15, where the switch from the first one of the one or more processing capabilities to the second one of the one or more processing capabilities is based on the measurement information.

18. The apparatus of claim 15, wherein if the measurement information for the first beam and the second beam are similar, and the first one of the processing capabilities is separate processing, the switch is from separate processing to joint processing.

19. The apparatus of claim 15, wherein if the measurement information for the first beam and the second beam indicate a strong separate TRP-RX pair or weak cross link between the multiple TRP-RX pairs, and the first one of the processing capabilities is joint processing, the switch is from joint processing to separate processing.

20. An apparatus comprising processing circuitry configured to:
process, based on signals received from a user equipment (UE), an indication indicating the UE is capable of joint processing, separate processing, or both joint and separate processing, and wherein the UE is configured to receive a first beam from a first transmission and reception point (TRP) and a second beam from a second TRP such that the UE is configured to receive multiple TRP-RX pairs from the first TRP and the second TRP; and
generate, for transmission to the UE, configuration information identifying, based on the indication of the processing capability, a suitable multi-TRP transmission scheme and which processing capability for the UE to use for multi-TRP reception with the first TRP and the second TRP.
